(19) United States
(12) Patent Application Publication
(10) Pub. No.: US 2010/0064604 A1
(43) Pub. Date: Mar. 18, 2010

(54) GLASS PANE ARRANGEMENT AND METHOD FOR PRODUCING SAME

(76) Inventor: Heiko TRAUTZ, Pforzheim (DE)

Correspondence Address: HARNESS, DICKEY & PIERCE, P.L.C., P.O. BOX 828, BLOOMFIELD HILLS, MI, 48303, US

(21) Appl. No.: 12/562,212

(22) Filed: Sep. 18, 2009

Related U.S. Application Data
(63) Continuation of application No. PCT/EP2008/002035, filed on Mar. 13, 2008.

(30) Foreign Application Priority Data
Mar. 19, 2007 (DE) 10 2007 013 667.8
May 2, 2007 (DE) 10 2007 020 537.8

(51) Int. Cl. E06B 3/66; E06B 3/64; E06B 7/12; E06B 3/673; E06B 7/16

(52) U.S. Cl. 52/172; 52/204.593; 52/745.15; 52/788.1

(57) ABSTRACT

The invention relates to a glass pane arrangement comprising:
a first and a second glass pane which are parallel to one another and spaced apart from one another via a spacer element extending in the edge region,
a first sealing element which extends adjacent to the spacer element in the edge region and surrounds a glass pane interior, and
a filler located in the interior.

The glass pane arrangement has a sleeve which extends outward from the interior through the sealing element and has a passage from outside into the interior, wherein the passage is sealed by a second sealing element.

### CROSSREFERENCES TO RELATED APPLICATIONS

This application is a continuation of copending international patent application PCT/EP2008/002035 filed on Mar. 13, 2008 and designating the U.S., which was published in German and claims priority to German patent applications DE 10 2007 013 667.8, filed on Mar. 19, 2007 and DE 10 2007 020 537.8 filed on May 2, 2007. The entire contents of these related applications are incorporated herein by reference.

### BACKGROUND OF THE INVENTION

The present invention relates to a glass pane arrangement comprising a first and a second glass pane which are parallel to one another and spaced apart from one another via a spacer element extending in the edge region, a first sealing element which extends adjacent to the spacer element in the edge region and surrounds a glass pane interior, and a filler located in the interior. The present invention also relates to a method for producing a glass pane arrangement of this type.

### BACKGROUND OF INVENTION

Glass pane arrangements of the type mentioned above are used in the most diverse applications. If these arrangements are also intended to satisfy fireproofing requirements, a gel which is transparent after it has been cured is used as the filler along with the suitable glass panes. In existing glass pane arrangements, this gel is introduced into the interior via an opening in the spacer element and in the sealing element, with the opening then being closed by a sealing element.

The problem with this process is that it is not possible to reliably achieve a close bond between the subsequently introduced sealing element and the previously applied sealing element. The result of an insufficient bond between the two elements is that air can penetrate into the interior, where it results in visible air bubbles in the gel. Glass pane arrangements of this type are rejects and can no longer be used. This is not just because the air bubbles are visible and impair the esthetic impression, but also because the air which is present may impair the function of the gel.

Owing to the high reject rate, glass pane arrangements of this type for fireproofing purposes are currently very expensive.

### SUMMARY OF THE INVENTION

Against this background, an object of the present invention is to develop a glass pane arrangement of the type mentioned above in such a way as to reduce the risk of air penetrating into the interior while ensuring that the production process remains simple.

This and other objects are achieved by the glass pane arrangement mentioned in the introduction by the provision of a sleeve which extends outward from the interior through the sealing element and has a passage from outside into the interior, wherein the passage is sealed by a second sealing element.

In other words, this means that a direct bond is no longer necessary between the sealing element applied first and the subsequently applied sealing element since the sleeve is situated between these two elements. A reliable bond to the sealing element may be established by appropriate selection of the sleeve material.

Therefore, there is no longer the problem that the subsequently introduced sealing element no longer enters into a bond with the already cured sealing element.

The reliable, tight seal, which is achieved in this way, of the opening required to introduce the filler greatly reduces the amount of rejects caused by penetrating air. In addition, the sleeve which is used does not make the production process more complicated.

In a preferred development, the first and the second sealing element are produced from the same material. The material used for the first and the second sealing element is preferably a two-component material, preferably a two-component polysulfite sealing material.

The glass pane arrangement according to the invention is particularly advantageous if it is used for fireproofing purposes; in this case, the filler is a transparent gel which has a flame-retardant effect in the event of a fire and if one of the two glass panes is destroyed.

However, it is clear that the glass pane arrangement according to the invention can also be used for other applications, in which case suitably adapted glass panes and corresponding fillers are used. In addition, it is clear that the glass pane arrangement may have not only two but also more glass panes which are each held at a distance from one another.

In a preferred development, the sleeve is produced from metal and has a longitudinal region surrounded by a material which corresponds to the material of the spacer element and has a slightly greater height than the spacer element.

In other words, the sleeve is designed in such a way that it can fill a gap in the spacer element, with an opening also remaining through the sleeve into the interior. The greater height means that the material of the sleeve is pinched slightly and pressed laterally outward when the second glass pane is positioned, and therefore the material bears very effectively against the lateral spacer element.

With particular preference, the spacer element is produced from a butyl material.

With particular preference, the spacer element is applied to the first glass pane by spraying, wherein a gap, into which the sleeve can be inserted, is left free. It is also conceivable, of course, to apply or position the spacer element in another way.

The object on which the invention is based is also achieved by a process for producing a glass pane arrangement of this type, said process comprising the following steps:

a spacer element is applied to an edge region of a first glass pane, wherein a gap is left free,

a sleeve is inserted into the gap, wherein the sleeve has a passage,

a second glass pane is applied to the spacer element such that the two glass panes are parallel to one another and spaced apart from one another and form an interior between them,

the edge region between the two glass panes is sealed by a first sealing element, wherein the passage in the sleeve remains free,

a filler is introduced into the interior through the passage in the sleeve, and the sleeve is sealed by a second sealing element so as to completely seal the interior.

A glass pane arrangement having the advantages mentioned above is produced with the aid of this process according to the invention. In particular, the sealing of the interior is considerably improved as compared with existing solutions, and therefore the reject rate resulting from air bubbles, the precipitation of moisture etc. is considerably reduced.

With particular preference, the sealing element used is a two-component sealing material, wherein the first sealing element is cured after the edge region has been sealed.

With particular preference, the sleeve has a stopper which is pushed into the passage and is removed after the first sealing element has been cured.

The advantage of this measure is that no material can penetrate into the passage in the sleeve and thereby block the opening into the interior when the first sealing element is being applied.

With particular preference, the filling material used is a fire-resistant gel which is cured together with the second sealing element after the sleeve has been sealed.

It is furthermore preferred that air located in the interior is removed by pressing the two glass panes together slightly before the sleeve is sealed.

The object of the present invention is also achieved by a sleeve for a glass pane arrangement of this type, which sleeve is characterized in that it is produced from a material which enters into a good bond with the sealing element, and in that a spacer element, which corresponds in terms of height to the spacer element of the glass pane arrangement, is provided on a longitudinal portion.

With particular preference, a removable stopper is provided at that end of the sleeve which is situated opposite from the spacer element.

The advantage of this stopper is that it firstly facilitates handling, particularly during positioning on the first glass pane, and secondly ensures that nothing which would prevent subsequent filling of the interior passes into the passage in the sleeve when the first sealing element is being applied.

It is particularly preferred to produce the sleeve from stainless steel.

Further advantages and refinements of the invention emerge from the description and the appended drawing.

It goes without saying that the features mentioned above and those still to be explained below can be used not only in the respectively given combination but also in other combinations or on their own, without departing from the scope of the present invention.

### BRIEF DESCRIPTION OF THE DRAWINGS

The invention will now be explained in more detail on the basis of an exemplary embodiment and with reference to the drawing, in which:

FIGS. 1a, 1b show two schematic views of a glass pane with an applied spacer element;

FIGS. 2a-2c show different schematic views of a glass pane arrangement;

FIGS. 3a-3d show different illustrations of a sleeve;

FIGS. 4a-4c show different schematic views of an excerpt from the glass pane arrangement in the region of the sleeve; and

FIGS. 5a-5c show different schematic illustrations showing a filling device for filling an interior of the glass pane arrangement.

### DETAILED DESCRIPTION OF THE PREFERRED EMBODIMENTS

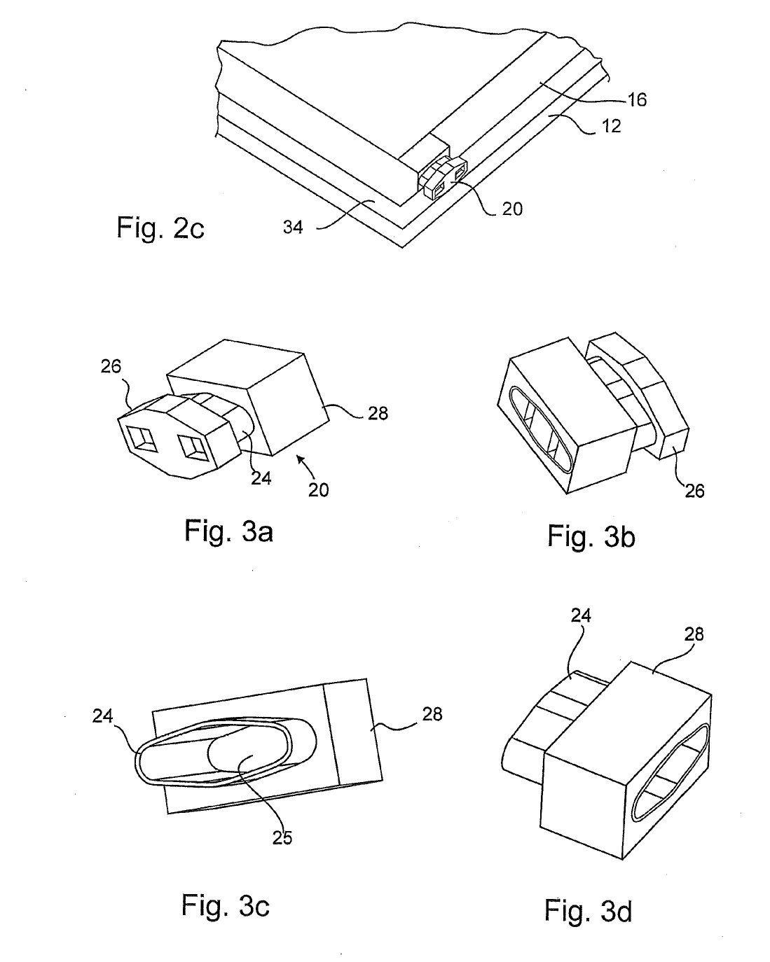

FIG. 2b shows a side view of a glass pane arrangement which is generally denoted by the reference numeral 10. A glass pane arrangement 10 of this type comprises a first glass pane 12 and a second glass pane 14. By way of example, the two glass panes 12, 14 may be specially toughened glass which is very heat-resistant.

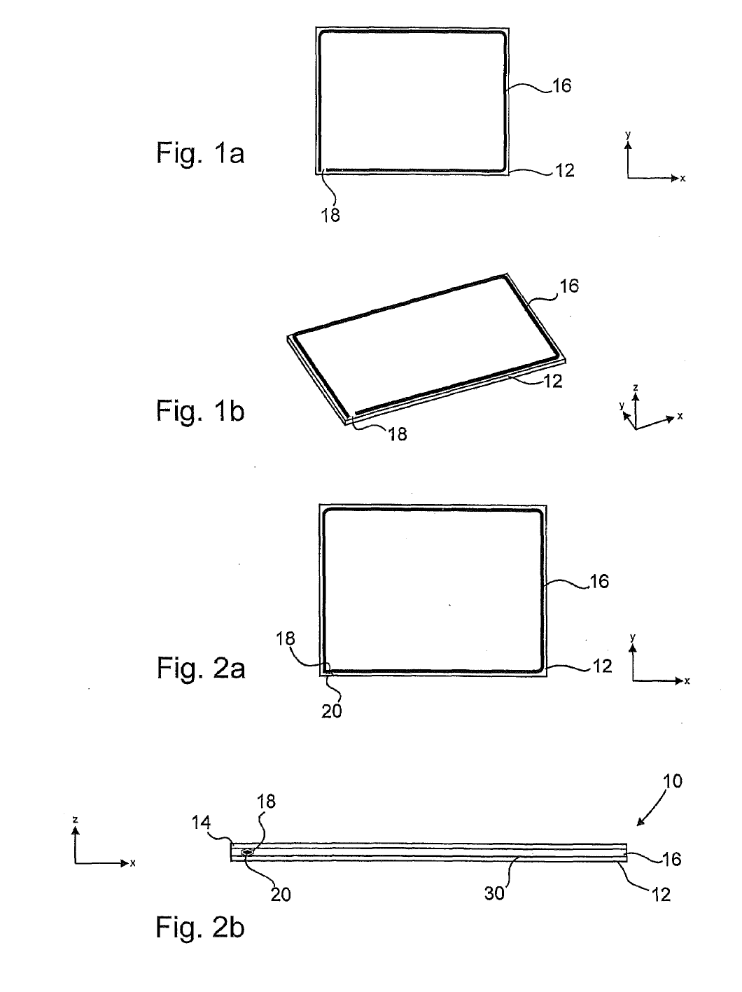

The two glass panes 12, 14 are arranged parallel to one another and spaced apart from one another, the distance between the two glass panes 12, 14 being defined via a spacer element 16. As can easily be seen in FIGS. 1a and 1b, this spacer element 16 extends in the edge region of the glass panes 12, 14 and extends virtually over the entire periphery of the glass pane. The spacer element 16 leaves only a small gap 18 free. The two glass panes 12, 14 and the spacer element 16 surround an interior denoted by the reference numeral 22. This interior 22 may be filled with different transparent materials, for example air, gas or transparent gels.

In order to completely seal the interior 22, the glass pane arrangement 10 has a sealing element 30 which extends over the entire periphery between the two glass panes 12, 14 and in front of the spacer element 16.

The glass pane arrangement 10 also comprises a sleeve 20 which is provided so as to enable a connection to be produced between the interior 22 through the spacer element 16 and the sealing element 30 to the outside. The design and method of operation of this sleeve are explained further in the text which follows.

In order to completely seal the interior 22 after a filler has been introduced, the passage in the sleeve is also sealed.

The glass pane arrangement 10 therefore comprises the two glass panes 12, 14, the spacer element 16, the sealing element 30 and the sleeve 20 which, for its part, is filled with a sealing element. In addition, the glass pane arrangement 10 comprises a filler in the interior 22.

A glass pane arrangement of this type is then produced as follows:

Firstly, the spacer element 16 is applied to the first glass pane 12; the material used in this process is usually butyl, which is sprayed on. As shown in FIG. 1a, the spacer element 16 extends over virtually the entire periphery in the edge region of the glass pane 12. Only a gap 18 is kept free. As can easily be seen from FIG. 2c, the sleeve 20 is then inserted into this gap 18. The sleeve 20 comprises a sleeve body 24 which surrounds a passage 25 and, at a longitudinal end, has a spacer element 28, the height of which is slightly greater than the height of the spacer element 16 and the width of which corresponds to the width of the gap 18. As a result, the sleeve together with the spacer element 28 fits precisely in the gap 18.

At this point in time of production, the passage 25 is closed at the outer longitudinal end by a stopper 26, the height of the stopper corresponding approximately to the height of the spacer element 16. The stopper 26 is designed such that it can be pulled out of the passage 25.

The sleeve body 24 is usually produced from metal, preferably stainless steel, while the spacer element 28 is produced from the same material as the spacer element 16, i.e. from butyl in the present exemplary embodiment.

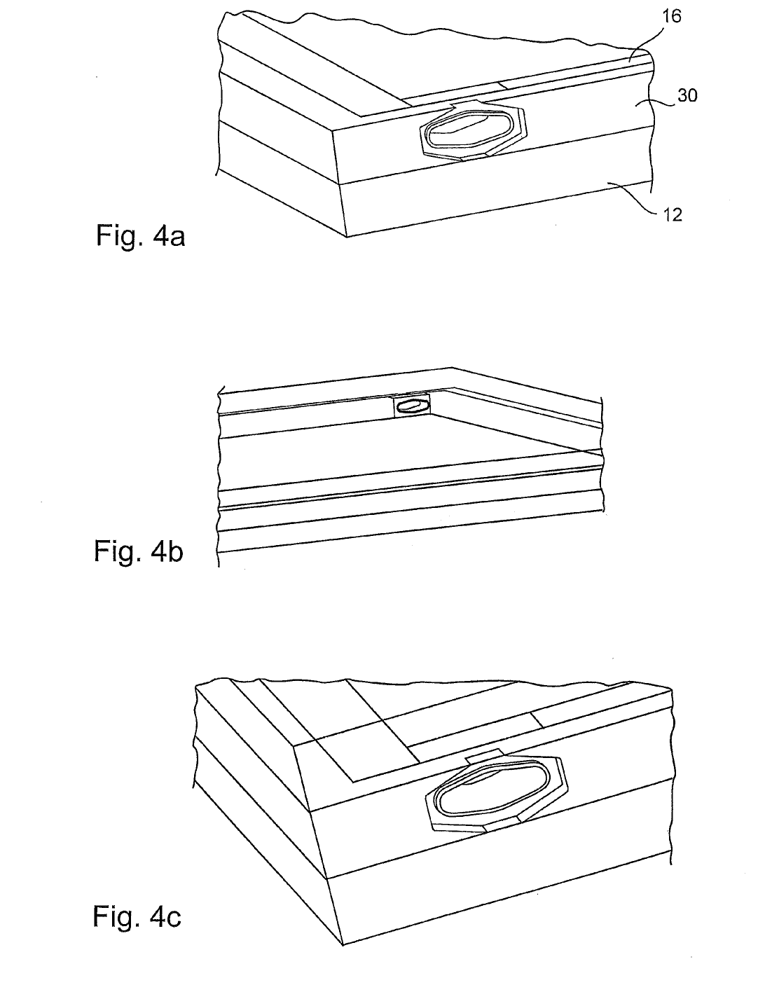

After the sleeve 20 has been introduced into the gap 18, the second glass pane 14 is positioned on the spacer element 16 or 28 in such a way that it is parallel with respect to the first glass pane 12. Since the spacer element 16 is set back slightly with respect to the edge of the glass pane 12 or 14, an edge region 34 which is filled with a sealing element 30 in the subsequent step is produced. A corresponding illustration is shown, for example, in FIGS. 4a to 4c.

The task of the sealing element 30 is firstly to bond the two glass panes 12, 14 to one another and secondly to seal the interior 22 with respect to the outside. However, the region around the stopper 26 of the sleeve 20 remains free. The sealing element 30 does not pass into this region.

A two-component material, such as polysulfite, is usually used for the sealing element 30. However, it goes without saying that other materials, in particular two-component materials, can likewise be used, as long as they satisfy the criteria and requirements mentioned above, specifically adhesive bonding and sealing.

As soon as the sealing element 30 is introduced into the edge region 34, the entire arrangement comprising the glass panes 12, 14, the spacer element 16, the sleeve 20 and the sealing element 30 is placed in a furnace in order to be toughened.

After the material of the sealing element 30 has been cured, the stopper 26 of the sleeve 20 is pulled out so as to produce a bond via the passage 25 in the interior 22 between the two glass panes 12, 14. FIGS. 4a to 4c show a corresponding illustration. This illustration clearly shows that the sealing element 30 surrounds the sleeve body 24 of the sleeve 20 virtually completely, at least in a rear region.

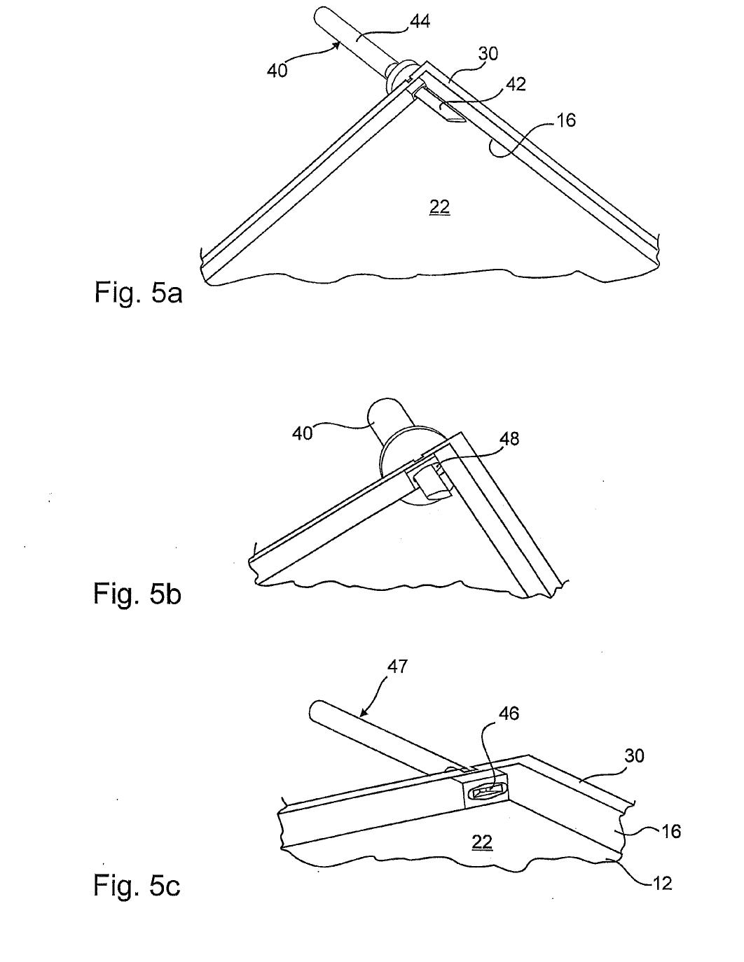

In order to then fill the interior 22 with a filler, in particular a gel, use is made of a filling device 40 as shown in FIGS. 5a to 5c. The filling device 40 comprises a tube 44 and an outlet end or nozzle 42 which is pushed through the passage 25 in the sleeve 20 and projects into the interior 22. The gel can then be introduced into the interior 22 through this tube 44 and the outlet end 42. The air present in the interior 22 is pressed to the outside via an intermediate space 48 in the passage 25. As soon as a predefined quantity of filler has been introduced into the interior 22, the outlet end 42 is pulled out.

A funnel-shaped element 46 is then inserted into the sleeve body 24; the narrow tubular end of this element extends outward and a piece of tube 47 is pushed onto said element. The two glass panes 12, 14 are then pressed together slightly such that air which may still be present in the region of the passage 25 is pressed out of the interior 22 to the outside through the funnel-shaped element 46 into the tube 47. As soon as only filler escapes into the tube, the funnel-shaped element 46 is closed, for example by the action of heat (e.g. welded), and therefore no more filler can escape.

In the next production step, the tube 47 is withdrawn and a sealing element 30, for example in the form of polysulfite, is introduced into and around the passage 25.

In the next step, the glass pane arrangement 10 is guided into a furnace in order to cure the gel present in the interior 22 and the material present in the passage 25 for sealing. Since the material used bonds very well to the inner wall of the sleeve body 24, a very good and close bond is obtained; this bond always ensures that neither air nor moisture can penetrate into the interior 22.

It has therefore been found that the glass pane arrangement 10 according to the invention provides considerable advantages over the existing solutions since the subsequent sealing of the passage 25 does not result in any bonding problems owing to the use of the sleeve 20 which, as it were, provides a bonding layer between the two sealing materials.

What is claimed is:

1. A glass pane arrangement comprising:
a first and a second glass pane which are parallel to one another and spaced apart from one another via a spacer element extending along an edge region,
a first sealing element which extends adjacent to the spacer element in the edge region and surrounds a glass pane interior,
a filler located in the interior, and
a sleeve which extends outward from the interior through the sealing element and has a passage from outside into the interior, wherein the passage is sealed by a second sealing element.

2. The glass pane arrangement as claimed in claim 1, wherein the first and the second sealing element are made from the same material.

3. The glass pane arrangement as claimed in claim 2, wherein the first and the second sealing element are made from a two-component material.

4. The glass pane arrangement as claimed in claim 3, wherein the two-component material is a two-component polysulfite sealing material.

5. The glass pane arrangement as claimed in claim 1, wherein the filler is a transparent gel.

6. The glass pane arrangement as claimed in claim 1, wherein the sleeve is produced from metal and has a longitudinal region surrounded by a material which corresponds to the material of the spacer element and has a slightly greater height than the spacer element.

7. The glass pane arrangement as claimed in claim 1, wherein the spacer element consists of a butyl material.

8. The glass pane arrangement as claimed in claim 1, wherein the spacer element is applied to the first glass pane by spraying, wherein a gap, into which the sleeve can be inserted, is left free.

9. A method for producing a glass pane arrangement, comprising the following steps:
applying a spacer element to an edge region of a first glass pane, wherein a gap is left free,
inserting a sleeve into the gap, wherein the sleeve has a passage,
applying a second glass pane to the spacer element such that the two glass panes are parallel to one another and spaced apart from one another and form an interior therebetween,
sealing the edge region between the two glass panes by a first sealing element, wherein the passage in the sleeve remains free,
introducing a filling material into the interior through the passage in the sleeve, and
sealing the sleeve by a second sealing element so as to completely seal the interior.

10. The method as claimed in claim 9, wherein the first sealing element is a two-component sealing material and wherein the first sealing element is cured after the edge region has been sealed.

11. The method as claimed in claim 10, wherein the sleeve has a stopper which is pushed into the passage, and the stopper is removed after the first sealing element has been cured.

12. The method as claimed in claim 11, wherein the filling material is a fire-resistant gel which is cured together with the second sealing element after the sleeve has been sealed.

13. The method as claimed in claim 9, wherein air located in the interior is removed by pressing the two glass panes together slightly before the sleeve is sealed.

14. The method as claimed in claim 9, wherein said glass pane arrangement comprises:
a first and a second glass pane which are parallel to one another and spaced apart from one another via a spacer element extending in the edge region,
a first sealing element which extends adjacent to the spacer element in the edge region and surrounds a glass pane interior,
a filler located in the interior, and
a sleeve which extends outward from the interior through the sealing element and has a passage from outside into the interior, wherein the passage is sealed by a second sealing element.

15. A sleeve for a glass pane arrangement, comprising a first and a second glass pane which are parallel to one another and spaced apart via a spacer element extending along an edge region, a sealing element which extends adjacent to the spacer element in the edge region and surrounds a glass pane interior, and the sleeve which extends outward from the interior through the sealing element,
wherein said sleeve is produced from one material, in that said sleeve enters into a good bond with the sealing element, and further wherein the height of the spacer element is slightly greater than the height of the spacer element of the glass pane arrangement, and is provided on a longitudinal end portion.

16. The sleeve as claimed in claim 15, wherein a removable stopper is provided at that end of the sleeve which is situated opposite from the spacer element.

17. The sleeve as claimed in claim 15, wherein the sleeve is produced from stainless steel.
